(19) United States
(12) Patent Application Publication
(10) Pub. No.: US 2026/0359196 A1
(43) Pub. Date: Nov. 12, 2026

(54) GAME TESTING AND ANALYSIS USING AUTONOMOUS AI SYSTEM

(71) Applicant: A K Affran Ullah, Dhaka (BD)

(72) Inventor: A K Affran Ullah, Dhaka (BD)

(21) Appl. No.: 19/276,120

(22) Filed: Jul. 22, 2025

Related U.S. Application Data
(60) Provisional application No. 63/801,898, filed on May 8, 2025.

(51) Int. Cl. G06F 11/362

(52) U.S. Cl. CPC G06F 11/362

(57) ABSTRACT

A computing system for automated game testing and analysis, comprising: a module for automated game installation; a gameplay simulation engine using AI agents; a telemetry and bug detection layer; a design analysis module; a natural-language feedback interface; and a multi-user review layer. The computing system installs a game into a virtual environment, launches and simulates gameplay using AI agents, collects gameplay telemetry and detects bugs, analyzes design metrics, and generates feedback in conversational language

### CROSS-REFERENCE TO RELATED APPLICATIONS

This application is a Utility Patent application claiming priority to U.S. Provisional Patent Application Ser. No. 63/801,898, filed on May 8, 2025, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present disclosure relates to artificial intelligence systems for software quality assurance, and more particularly to an autonomous AI-driven system for game installation, testing, design analysis, and conversational feedback generation.

### 2) Description of Related Art

Game development and quality assurance processes have traditionally been time-consuming and resource-intensive endeavors. As digital games become increasingly complex, with intricate mechanics, expansive environments, and sophisticated user interfaces, the challenges associated with thorough testing and analysis have grown exponentially.

Conventional game testing methodologies often rely heavily on manual processes, where human testers play through various scenarios to identify bugs, assess gameplay balance, and evaluate user experience. This approach, while valuable for certain aspects of game evaluation, can be limited in its scope and consistency. Human testers may inadvertently overlook issues, struggle to replicate specific bug conditions, or provide subjective feedback that varies between individuals.

Additionally, the installation and configuration of games across multiple platforms and environments can be a tedious process, prone to human error and inconsistencies. This can lead to delays in the testing cycle and potentially mask platform-specific issues that may not be immediately apparent.

The field of game design analysis also presents challenges in traditional development workflows. Evaluating complex game systems, player progression curves, and monetization strategies often requires extensive playtesting and data collection. This process can be time-consuming and may not always yield comprehensive insights into the nuances of player behavior and engagement.

As the gaming industry continues to evolve, there is a growing need for more efficient, consistent, and data-driven approaches to game testing and analysis. Automation technologies and artificial intelligence have shown promise in various aspects of software development, suggesting potential applications in streamlining game quality assurance processes.

The integration of machine learning and natural language processing in software testing environments has opened new possibilities for enhancing bug detection, performance analysis, and user experience evaluation. However, applying these technologies effectively to the unique challenges of game development requires careful consideration of the interactive and dynamic nature of video games.

Since game design analysis presents these challenges, there is a need for a system which integrates installation automation, AI gameplay, comprehensive bug detection, design analysis, NLP-driven conversational feedback, and multi-user collaboration.

There exists an opportunity to explore innovative approaches that combine automated testing methodologies with advanced AI-driven analysis to address the complexities of modern game development. Such solutions could potentially offer more comprehensive coverage, faster iteration cycles, and deeper insights into game design and player behavior.

### BRIEF SUMMARY OF THE INVENTION

According to an aspect of the present disclosure, a computing system is provided. The computing system includes a module for automated game installation, a gameplay simulation engine using AI agents, a telemetry and bug detection layer, a design analysis module, a natural-language feedback interface, and a multi-user review layer. The computing system installs a game into a virtual environment, launches and simulates gameplay using AI agents, collects gameplay telemetry and detects bugs, analyzes design metrics, and generates feedback in conversational language.

According to other aspects of the present disclosure, the computing system may include one or more of the following features. The system may include instructions being run on a mobile platform or PC, the instructions run within secure sandbox or emulation environments, the system performing steps of autonomous installing at least one digital game onto a PC including real-time progress indicators and status reporting. The system may include autonomous gameplay simulation and bug detection, wherein AI-driven agents employ reinforcement learning or decision-tree methodologies to autonomously navigate and play test scenarios without predefined scripts. The system may include comprehensive detection and categorization of gameplay bugs and errors, including graphical, functional, and performance-related issues, utilizing advanced telemetry, computer vision, and machine learning analytics.

According to another aspect of the present disclosure, the system includes AI-Enhanced Game Design Evaluation. The AI-Enhanced Game Design Evaluation includes automated evaluation of core gameplay mechanics, including difficulty progression, reward structures, player retention strategies, interface efficiency, and overall user experience optimization.

According to other aspects of the present disclosure, the system may include one or more of the following features. The system may include identification of gameplay design flaws, frustration points, and user-experience bottlenecks through continuous AI-driven analysis. The system may include an interactive conversational feedback interface including natural-language processing (NLP) and generative AI techniques to provide clear, conversational explanations of complex QA results and design analysis, and interactive query and response capability enabling developers, designers, and project managers to effectively engage and interpret AI-generated insights. The system may include collaborative multi-user engagement including an integrated multi-user environment allowing simultaneous collaborative review, annotation, and discussion of AI findings and recommendations.

One aspect of the invention is a computing system for automated game testing and analysis. The computing system includes an installation module for automated game installation and a gameplay simulation engine using AI agents. The computing system includes a telemetry and bug detection layer. The computing system includes a design analysis module, a natural-language feedback interface and a multi-user review layer. The computing system installs a game into a virtual environment, launches and simulates gameplay using AI agents, collects gameplay telemetry and detects bugs, analyzes design metrics, and generates feedback in conversational language. The installation module may operate within secure sandbox or emulation environments. The installation module may provide real-time progress indicators and status reporting during game installation. The gameplay simulation engine may use reinforcement learning algorithms to enable AI agents to autonomously navigate and play test scenarios without predefined scripts. The gameplay simulation engine may incorporate decision-tree methodologies for AI agent decision-making. The telemetry and bug detection layer may use computer vision techniques to analyze visual output of the game for graphical glitches and rendering issues. The telemetry and bug detection layer may employ machine learning analytics to identify patterns and anomalies in collected gameplay data. The design analysis module may evaluate core gameplay mechanics, difficulty progression, reward structures, and overall user experience flow. The design analysis module may identify gameplay design flaws, frustration points, and user-experience bottlenecks through continuous AI-driven analysis.

Another aspect of the invention is a method for automated game testing and analysis. The method includes automatically installing a game into a virtual environment, simulating gameplay using AI agents, collecting gameplay telemetry and detecting bugs, analyzing game design metrics and generating feedback in conversational language. The step of automatically installing the game includes creating a sandboxed environment within which to install and run the game. The method may include providing real-time progress indicators and status reporting during game installation. The step of simulating gameplay using AI agents includes employing reinforcement learning algorithms to enable the AI agents to autonomously navigate and play test scenarios without predefined scripts. The method may include incorporating decision-tree methodologies for AI agent decision-making during gameplay simulation. The step of collecting gameplay telemetry and detecting bugs includes utilizing computer vision techniques to analyze visual output of the game for graphical glitches and rendering issues. The method may include employing machine learning analytics to identify patterns and anomalies in collected gameplay data for bug detection and categorization.

Another aspect of the invention is a non-transitory computer-readable medium storing instructions that, when executed by a processor, cause the processor to perform operations for automated game testing and analysis. The operations include installing a game into a virtual environment, simulating gameplay using AI agents, collecting gameplay telemetry and detecting bugs, analyzing game design metrics, and generating feedback in conversational language. Installing the game may create a sandboxed environment within which to install and run the game. Operations may include providing real-time progress indicators and status reporting during game installation. Simulating gameplay using AI agents may include employing reinforcement learning algorithms to enable the AI agents to autonomously navigate and play test scenarios without predefined scripts.

The system and method described integrate installation automation, AI gameplay, comprehensive bug detection, design analysis, NLP-driven conversational feedback, and multi-user collaboration in autonomous AI-driven for game installation, testing, design analysis, and conversational feedback generation.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a diagram showing a computing system for automated game testing and analysis, according to an embodiment.

FIG. 2 illustrates a flowchart of a game testing and analysis process, according to aspects of the present disclosure.

FIG. 3 illustrates a feedback system diagram showing interaction between game, AI, and NLP feedback components, according to an embodiment.

FIG. 4 shows a user interface display for an AI-driven game testing and analysis system, in accordance with example embodiments.

FIG. 5 is a diagram showing a method for automated game testing and analysis.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The present disclosure relates to an autonomous AI system for game testing and analysis. This system integrates advanced artificial intelligence techniques to streamline the process of game installation, comprehensive testing, design evaluation, and feedback generation. The system operates without human intervention, providing a fully automated solution for game developers and quality assurance teams.

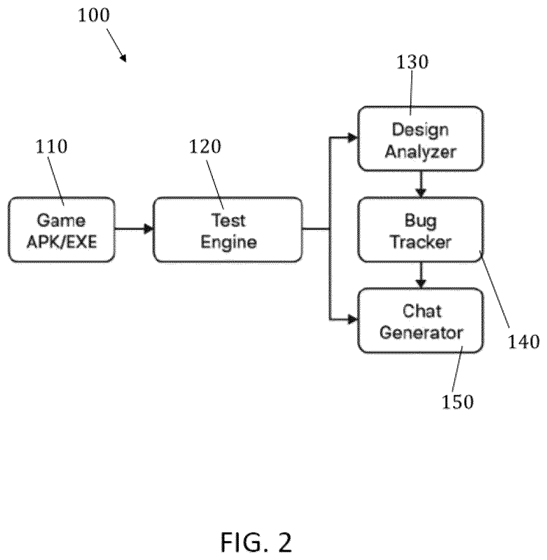

FIG. 2 illustrates a process 100 for game testing and analysis. The process 100 begins with a step 110, which represents the input of a game file. This game file undergoes testing in a step 120, which serves as the core testing engine. The subsequent steps branch into specialized functions: a step 130 for design analysis, a step 140 for bug tracking, and a step 150 for generating conversational feedback.

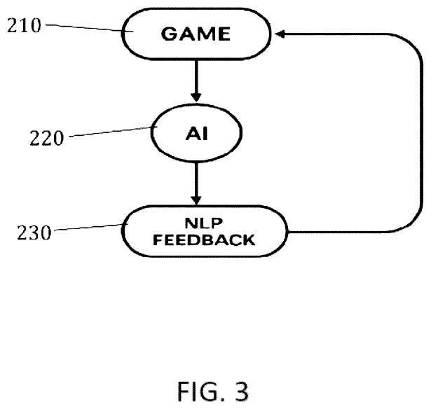

FIG. 3 depicts a feedback system diagram 200, showcasing the interaction between key components of the autonomous AI system. A game module 210 provides input to an ai module 220, which processes the game information. The processed data then flows to an NLP feedback module 230, which generates natural language feedback that loops back to the game module 210.

The system incorporates AI-driven gameplay simulation, utilizing reinforcement learning and decision-making algorithms to navigate through game scenarios. This approach enables comprehensive testing without relying on predefined scripts, allowing for more thorough and adaptive exploration of game content.

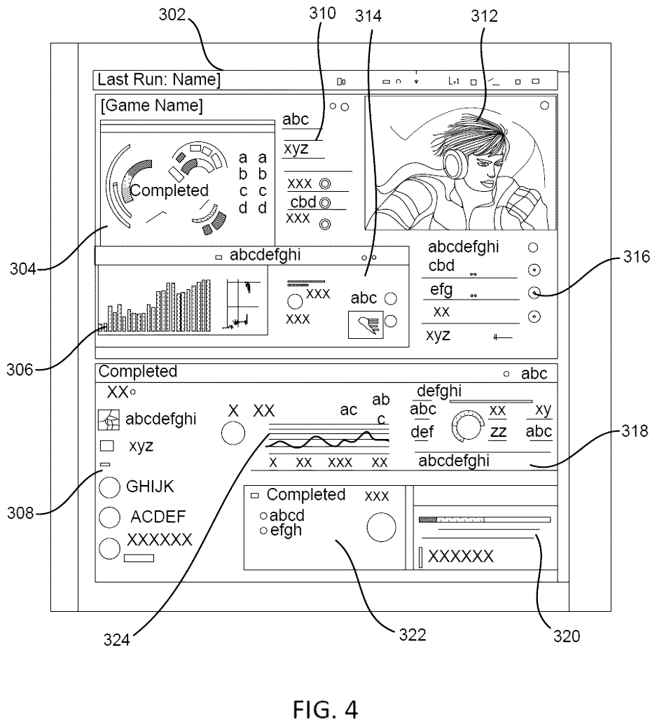

FIG. 4 presents a user interface display 300 of the autonomous AI system. The display includes an information header 302 containing run information and game details. A status window 304 and a status indicator 310 provide real-time updates on system operations. A comparative graph 306 visualizes time-based results, while a compliance window 308 and a compliance indicator 322 showcase adherence to testing standards.

The user interface display 300 features a gameplay window 312, allowing users to observe the AI-driven testing in action. An analysis module 314 and a feedback interface 316 present insights derived from the testing process. A results panel 318 summarizes testing outcomes, and a metrics display 320 shows quantitative data related to the testing process. A status report 324 provides detailed compliance information.

The autonomous AI system employs advanced computer vision and machine learning techniques to detect and categorize various types of bugs, including graphical glitches, functional errors, and performance issues. This comprehensive approach to bug detection enhances the overall quality assurance process.

In addition to testing, the system conducts in-depth analysis of game design elements. This includes evaluation of core gameplay mechanics, difficulty progression, reward structures, and overall user experience. The AI-driven analysis identifies potential design flaws, frustration points, and areas for improvement in the game's structure and flow.

A key feature of the system is its ability to generate conversational feedback. Utilizing natural language processing and generative AI techniques, the system transforms complex testing results and design analyses into clear, easily understandable explanations. This feature facilitates effective communication of insights to developers, designers, and project managers, regardless of their technical expertise.

The autonomous AI system for game testing and analysis represents a significant advancement in the field of game development and quality assurance. By automating critical processes and providing intelligent, conversational feedback, the system enhances efficiency, reduces human error, and contributes to the overall improvement of game quality.

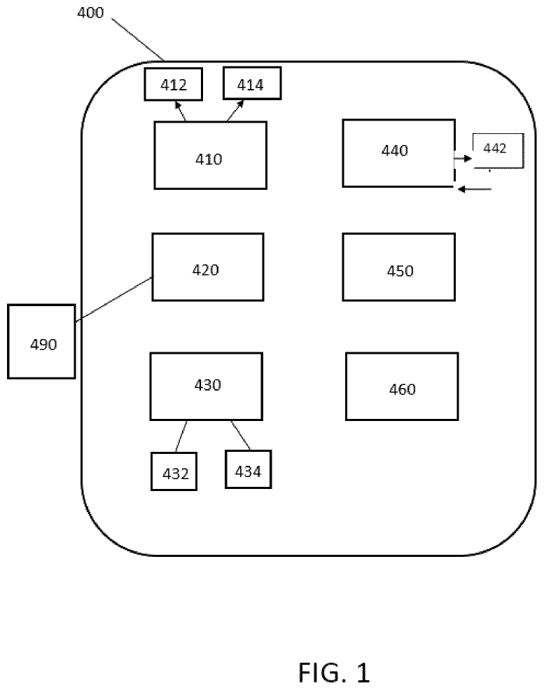

The autonomous AI system for game testing and analysis includes an installation automation module designed to streamline the process of installing games across multiple platforms. This module operates as part of the process 100 illustrated in FIG. 1, specifically within step 110 where the game file is initially processed.

The installation automation module functions to automatically install digital games on various computing platforms, including but not limited to personal computers, mobile devices, and cloud-based environments. In operation, the module first identifies the target platform for installation based on the game file type and system requirements.

For security purposes, the installation automation module creates a sandboxed or emulated environment within which to install and run the game. This approach ensures that the testing process does not interfere with or compromise the host system's integrity.

As the installation progresses, the module provides real-time progress indicators and status reporting. These features are visually represented in the user interface display 300 shown in FIG. 4. The status window 304 and status indicator 310 continuously update to reflect the current stage of the installation process, providing users with immediate feedback on the progress.

The installation automation module integrates with the game module 210 depicted in FIG. 3. Once the installation is complete, the game module 210 initiates the testing process by providing input to the ai module 220 for further analysis and testing.

In cases where installation encounters issues or requires specific configurations, the module automatically attempts to resolve these challenges. It logs all actions taken during the installation process, which are then accessible through the results panel 318 and status report 324 in the user interface display 300.

The installation automation module supports a wide range of game file formats and installation methods, adapting its approach based on the specific requirements of each game and platform. This flexibility enables the system to handle diverse game types and installation scenarios without manual intervention.

By automating the installation process, this module significantly reduces the time and effort required for setting up games for testing, contributing to the overall efficiency of the autonomous AI system for game testing and analysis.

The autonomous AI system for game testing and analysis incorporates an AI gameplay simulation engine as a core component. This engine operates within the ai module 220 depicted in FIG. 3, working in conjunction with the game module 210 to perform comprehensive gameplay testing without human intervention.

The AI gameplay simulation engine utilizes advanced artificial intelligence techniques to emulate realistic player behavior and interactions within the game environment. At the heart of this engine are AI agents designed to navigate and play through various test scenarios autonomously. These AI agents employ sophisticated reinforcement learning algorithms to adapt and improve their gameplay strategies over time.

Reinforcement learning enables the AI agents to learn from their interactions with the game environment, optimizing their decision-making processes based on rewards and penalties encountered during gameplay. This approach allows the AI agents to explore a wide range of gameplay possibilities, uncovering potential issues or bugs that traditional scripted testing methods often miss.

In addition to reinforcement learning, the AI gameplay simulation engine also incorporates decision-tree methodologies. These decision trees provide a structured framework for the AI agents to make choices at key decision points within the game. By combining reinforcement learning with decision trees, the engine achieves a balance between exploratory behavior and goal-oriented testing.

The AI agents operate without predefined scripts, allowing for dynamic and adaptive testing that closely mimics real-world player behavior. This unscripted approach enables the discovery of edge cases and unexpected scenarios that scripted tests often overlook. The AI agents continuously learn and refine their strategies as they progress through the game, adapting to new challenges and game mechanics encountered.

During the testing process, the AI gameplay simulation engine generates extensive telemetry data, which is then analyzed by other components of the system. This data includes information on player actions, in-game events, performance metrics, and any encountered bugs or glitches. The collected data is processed and visualized in various elements of the user interface display 300 shown in FIG. 4, such as the gameplay window 312, analysis module 314, and results panel 318.

The AI gameplay simulation engine integrates seamlessly with the overall testing process 100 illustrated in FIG. 2. After the game file is processed in step 110 and enters the test engine in step 120, the AI agents begin their autonomous gameplay simulation. The data generated during this simulation feeds into subsequent steps, including the design analyzer 130, bug tracker 140, and chat generator 150.

By leveraging advanced AI techniques for gameplay simulation, the autonomous AI system for game testing and analysis achieves comprehensive coverage of game content and mechanics. This approach significantly enhances the efficiency and effectiveness of the testing process, enabling the identification of issues and design flaws that traditional testing methods often miss.

The autonomous AI system for game testing and analysis incorporates a sophisticated telemetry and bug detection layer as a crucial component of the testing process. This layer operates within the process 100 illustrated in FIG. 2, specifically as part of the test engine 120 and bug tracker 140 steps.

The telemetry and bug detection layer collects comprehensive gameplay data during the AI-driven testing process. This data includes player actions, in-game events, performance metrics, and system-level information. The layer utilizes advanced telemetry techniques to capture a wide range of data points, enabling thorough analysis of game behavior and performance.

In conjunction with data collection, the layer employs computer vision techniques to analyze the visual output of the game. This computer vision-based approach allows for the detection of graphical glitches, rendering issues, and other visual anomalies that traditional data-based methods might miss. The system processes the game's visual output in real-time, comparing it against expected visual patterns and identifying deviations.

Machine learning analytics play a significant role in the bug detection process. The system utilizes trained models to identify patterns and anomalies in the collected data and visual output. These models are capable of detecting a wide range of issues, including:
1. Functional bugs: Errors in game logic, quest progression, or interaction mechanics.
2. Performance issues: Frame rate drops, loading time anomalies, or memory leaks.
3. Graphical glitches: Texture errors, model clipping, or animation glitches.
4. Gameplay imbalances: Unexpected difficulty spikes or progression bottlenecks.

The telemetry and bug detection layer integrates closely with the ai module 220 shown in FIG. 3. As the AI-driven gameplay simulation progresses, the layer continuously monitors and analyzes the game's behavior, feeding information back to the ai module 220 for adaptive testing strategies.

Data collected and analyzed by the telemetry and bug detection layer is presented through various elements of the user interface display 300 depicted in FIG. 4. The gameplay window 312 showcases the visual output being analyzed, while the analysis module 314 and results panel 318 display detected issues and anomalies. The metrics display 320 presents quantitative data related to performance and bug detection.

The system categorizes detected bugs and issues based on severity, frequency, and impact on gameplay. This categorization helps prioritize issues for developers and QA teams, streamlining the debugging and optimization process. The status report 324 in the user interface display 300 provides detailed information on detected bugs and their classifications.

By combining advanced telemetry, computer vision, and machine learning analytics, the telemetry and bug detection layer of the autonomous AI system for game testing and analysis provides comprehensive and accurate identification of various types of bugs and errors. This approach significantly enhances the efficiency and effectiveness of the game testing process, enabling developers to identify and address issues more rapidly and thoroughly than traditional manual testing methods.

The autonomous AI system for game testing and analysis incorporates a game design analysis module as a critical component for evaluating and optimizing game mechanics and user experience. This module operates within the process 100 illustrated in FIG. 2, specifically as part of the design analyzer 130 step.

The game design analysis module integrates with the ai module 220 shown in FIG. 3, receiving input from the game module 210 and the AI-driven gameplay simulation. The module analyzes various aspects of game design, including core gameplay mechanics, difficulty progression, reward structures, and overall user experience flow.

In analyzing core gameplay mechanics, the module examines the fundamental interactions and systems that form the basis of the game. This includes evaluating the responsiveness of controls, the consistency of game rules, and the balance between different gameplay elements. The module utilizes data collected during the AI-driven gameplay simulation to assess the effectiveness and engagement level of these core mechanics.

The difficulty progression analysis focuses on evaluating how the game's challenge level changes over time. The module examines factors such as the rate at which new obstacles or enemies are introduced, the complexity of puzzles or challenges, and the overall learning curve for players. By analyzing the AI agent's performance and adaptation to increasing difficulty, the module identifies potential issues in the game's difficulty curve.

Reward structures are another key aspect evaluated by the game design analysis module. The module assesses the frequency, type, and impact of rewards given to players throughout the game. This includes analyzing the balance between intrinsic rewards (such as story progression or character development) and extrinsic rewards (like in-game currency or power-ups). The module uses data on player progression and engagement levels to determine the effectiveness of the reward system in motivating continued play.

User experience (UX) flow analysis involves examining the overall journey of the player through the game. The module evaluates factors such as menu navigation, tutorial effectiveness, loading times, and the clarity of in-game objectives. By analyzing the AI agent's interactions with these elements, the module identifies potential friction points or areas where the user experience breaks down.

The game design analysis module employs advanced AI-driven analysis techniques to identify design flaws and user-experience bottlenecks. These techniques include pattern recognition algorithms that detect anomalies in player behavior or progression, predictive models that forecast potential engagement drop-off points, and comparative analysis against established game design heuristics.

In identifying design flaws, the module looks for inconsistencies in game mechanics, imbalances in difficulty or rewards, and areas where player engagement significantly drops. The AI-driven analysis compares the observed gameplay data against expected patterns and flags deviations for further investigation.

User-experience bottlenecks are identified through a combination of performance metrics and behavioral analysis. The module examines areas where the AI agent consistently struggles or where progress slows significantly. These bottlenecks are often indicative of unclear instructions, poorly designed interfaces, or overly complex game mechanics that hinder player progress.

The results of the game design analysis are presented through various elements of the user interface display 300 depicted in FIG. 4. The analysis module 314 showcases detailed breakdowns of design elements and their effectiveness. The metrics display 320 presents quantitative data related to player progression, engagement levels, and other key performance indicators. The results panel 318 summarizes identified design flaws and user-experience bottlenecks, providing actionable insights for game developers.

The game design analysis module also incorporates analysis of player emotional responses and behaviors that impact engagement and satisfaction. This is achieved through advanced AI algorithms that interpret gameplay patterns, decision-making processes, and interaction styles exhibited by the AI agent during testing. The module correlates these behaviors with known models of player psychology to infer emotional states and engagement levels at different points in the game.

By providing comprehensive analysis of game design elements and identifying potential issues, the game design analysis module enables developers to make data-driven decisions for improving game quality and player experience. This AI-driven approach to game design evaluation represents a significant advancement in the field of game development and quality assurance.

The autonomous AI system for game testing and analysis incorporates a natural language feedback interface as a key component for delivering insights to stakeholders. This interface operates within the process 100 illustrated in FIG. 2, specifically as part of the chat generator 150 step.

The natural language feedback interface integrates closely with the NLP feedback module 230 shown in FIG. 3. The NLP feedback module 230 receives processed data from the ai module 220 and transforms this technical information into clear, conversational explanations of QA results and design analysis.

To generate these explanations, the NLP feedback module 230 employs advanced natural language processing (NLP) and generative AI techniques. These techniques enable the system to interpret complex testing data and analytical insights, then produce human-readable summaries and critiques that are easily understood by developers, designers, and project managers, regardless of their technical expertise.

The natural language feedback interface provides interactive query and response capabilities, allowing stakeholders to engage effectively with the AI-generated insights. Users interact with the system through the feedback interface 316 displayed in the user interface display 300 of FIG. 4. This interface enables users to ask specific questions about test results, design evaluations, or bug reports using natural language queries.

In response to user queries, the NLP feedback module 230 generates context-aware responses tailored to the role and expertise of the user. For example, a developer querying about a specific bug receives a detailed technical explanation, while a project manager asking about overall game performance receives a higher-level summary focused on key metrics and trends.

The system supports multiple output formats to accommodate various user preferences and integration needs. The NLP feedback module 230 generates PDF summaries that provide comprehensive overviews of testing results and design analyses. These summaries are accessible through the results panel 318 in the user interface display 300.

For more structured data representation, the NLP feedback module 230 produces JSON files containing detailed test results, bug reports, and design evaluations. These structured data files facilitate integration with other development tools and databases, enhancing the overall workflow of the game development process.

In addition to text-based outputs, the natural language feedback interface includes voice narration capabilities. This feature allows stakeholders to receive audio summaries of key findings, enabling hands-free consumption of important information during meetings or while multitasking.

The interactive nature of the natural language feedback interface enhances collaboration among development team members. Multiple users access the system simultaneously through the user interface display 300, reviewing AI-generated insights, annotating findings, and discussing recommendations in real-time. By transforming complex testing and analytical data into accessible, conversational language, the natural language feedback interface of the autonomous AI system for game testing and analysis significantly improves communication efficiency and decision-making processes in game development projects.

The autonomous AI system for game testing and analysis incorporates a multi-user review layer as part of the user interface display 300 shown in FIG. 3. This layer facilitates collaborative engagement with the AI-generated insights and recommendations produced by the system. The multi-user review layer integrates seamlessly with other components of the user interface display 300, including the analysis module 314, feedback interface 316, and results panel 318. Multiple users access the system simultaneously through this integrated environment, enabling real-time collaboration on test results and design evaluations. Within the multi-user review layer, users have the ability to annotate specific findings or sections of the AI-generated reports. These annotations are visible to all users with access to the system, fostering discussion and knowledge sharing among team members. The layer supports various annotation types, such as text comments, highlighting, and custom tags, allowing users to categorize and prioritize different aspects of the analysis.

The collaborative review process is enhanced by a discussion feature within the multi-user review layer. Users engage in threaded conversations directly linked to specific elements of the AI findings or recommendations. These discussions are contextualized, ensuring that all relevant information is readily available to participants.

The multi-user review layer also incorporates version control functionality. As users make annotations or engage in discussions, the system tracks changes and maintains a history of revisions. This feature allows team members to review the evolution of insights and decisions over time, providing valuable context for ongoing development efforts.

Integration with the feedback system diagram 200 illustrated in FIG. 2 enables the multi-user review layer to incorporate real-time updates from the NLP feedback module 230. As new insights are generated or existing analyses are refined, these updates are immediately reflected in the collaborative environment, ensuring that all users have access to the most current information.

The multi-user review layer also facilitates role-based access and customization. Different user roles, such as developers, designers, or project managers, are assigned specific permissions and view configurations. This approach ensures that each team member sees the most relevant information for their role while maintaining a collaborative environment.

To support asynchronous collaboration, the multi-user review layer includes notification features. Users receive alerts when new annotations are added, discussions are initiated, or significant updates occur in areas of interest. These notifications are integrated with the status window 304 and status indicator 310 of the user interface display 300, keeping all team members informed of ongoing collaborative activities.

The multi-user review layer enhances the overall effectiveness of the autonomous AI system for game testing and analysis by fostering collaborative decision-making and ensuring that insights derived from AI-driven testing are thoroughly reviewed and discussed by the development team.

The autonomous AI system for game testing and analysis integrates multiple components to perform comprehensive evaluation and feedback generation. The process 100 illustrated in FIG. 2 outlines the overall workflow of the system.

The workflow begins with the game installation, represented by step 110 in FIG. 2. The installation automation module processes the game file and installs it in a secure environment. Once installed, the game enters the test engine in step 120.

Within the test engine, the AI gameplay simulation engine, part of the ai module 220 shown in FIG. 3, initiates the testing process. The AI agents navigate through the game, simulating realistic player behavior and interactions. As the AI agents progress through the game, the telemetry and bug detection layer continuously monitors and analyzes the gameplay.

The data collected during the AI-driven gameplay simulation feeds into multiple analysis components. The design analyzer, represented by step 130 in FIG. 2, evaluates various aspects of game design, including core mechanics, difficulty progression, and user experience flow. Simultaneously, the bug tracker in step 140 categorizes and logs any detected issues or anomalies.

The analysis results from both the design analyzer and bug tracker are then processed by the NLP feedback module 230, shown in FIG. 3. This module transforms the technical data and insights into clear, conversational language, generating comprehensive feedback for stakeholders.

The user interface display 300, illustrated in FIG. 4, serves as the central hub for presenting the system's outputs and facilitating user interaction. The gameplay window 312 displays the AI-driven testing in real-time, while the analysis module 314 and results panel 318 showcase the findings from the design analysis and bug tracking processes. The feedback interface 316 enables users to interact with the system, querying specific aspects of the test results or design evaluations. The NLP feedback module 230 processes these queries and generates context-aware responses, presenting them through the feedback interface 316. Throughout the testing and analysis process, the status window 304 and status indicator 310 provide real-time updates on the system's progress. The metrics display 320 presents quantitative data related to the testing process and game performance. The system integrates with external project management tools such as Slack or Jira. This integration enables seamless communication of test results, bug reports, and design recommendations to development teams. The status report 324 in the user interface display 300 includes options for exporting data to these external systems, facilitating efficient workflow management and issue tracking.

The feedback system diagram 200 in FIG. 3 illustrates the continuous loop of information flow between the game module 210, ai module 220, and NLP feedback module 230. This iterative process ensures that the system adapts to new information and refines its analysis over time, providing increasingly accurate and relevant insights for game developers and quality assurance teams.

Returning to FIG. 4, the user interface display 300 of the autonomous AI system for game testing and analysis presents a comprehensive view of the testing process, analysis results, and system status information. The interface is designed to provide stakeholders with clear, actionable insights derived from the AI-driven testing and evaluation processes. The user interface display 300 is organized into distinct sections, each serving a specific purpose in the presentation of data and system interactions. At the top of the display, the information header 302 contains essential details about the current testing session, including the name of the game being analyzed and information about the last test run. Positioned in the upper left portion of the user interface display 300, the status window 304 provides real-time updates on the system's operations. This window displays information such as the current stage of testing, progress indicators, and any notable events occurring during the analysis process. Adjacent to the status window 304, the status indicator 310 offers a quick visual reference for the overall system status, using color-coded signals or icons to represent different states of operation. Below the status window 304, the comparative graph 306 presents time-based results data in a bar graph format. This visualization allows users to quickly assess trends and patterns in game performance or testing metrics over time. The graph is interactive, enabling users to zoom in on specific time periods or data points for more detailed analysis. The gameplay window 312, situated in the upper right quadrant of the user interface display 300, showcases the current game being analyzed. This window provides a real-time view of the AI-driven gameplay simulation, allowing stakeholders to observe the testing process as it unfolds. The gameplay window 312 is particularly useful for identifying visual bugs or anomalies that the system detects during testing. To the right of the gameplay window 312, the analysis module 314 and feedback interface 316 are integrated into the display. The analysis module 314 presents detailed insights derived from the game design analysis and bug detection processes. It includes breakdowns of gameplay mechanics, difficulty progression, and user experience evaluations. The feedback interface 316 serves as the primary point of interaction between users and the system's natural language processing capabilities, allowing stakeholders to query specific aspects of the test results or design evaluations. In the lower right section of the user interface display 300, the results panel 318 summarizes key findings from the testing and analysis processes. This panel highlights critical issues, notable performance metrics, and actionable recommendations for game improvement. Adjacent to the results panel 318, the metrics display 320 presents quantitative data related to the testing process, including performance benchmarks, bug counts, and other relevant statistics.

The lower portion of the user interface display 300 contains the compliance window 308, which provides information on how well the game adheres to various testing standards and quality benchmarks. This window is complemented by the compliance indicator 322, which offers a quick visual reference for overall compliance status. At the bottom of the user interface display 300, the status report 324 provides detailed compliance information and a comprehensive overview of the testing session. This report includes summaries of detected issues, performance evaluations, and design recommendations, serving as a central repository for all key findings generated by the system. The layout of the user interface display 300 is designed to facilitate efficient information processing and decision-making. The arrangement of elements follows a logical flow, guiding users from high-level status information to detailed analysis results. The interface utilizes a consistent color scheme and design language throughout, enhancing readability and user comprehension. Interactive elements within the user interface display 300 allow users to drill down into specific data points, toggle between different views, and customize the display according to their preferences or role-specific needs. For example, developers can focus on technical details and bug reports, while project managers can access high-level summaries and performance metrics. The user interface display 300 integrates seamlessly with the overall system architecture depicted in the feedback system diagram 200. Data generated by the game module 210 and processed by the ai module 220 is presented through various components of the interface. The NLP feedback module 230 powers the interactive elements of the feedback interface 316, enabling natural language interactions with the system's insights and recommendations. By presenting complex testing and analysis data in a clear, visually intuitive format, the user interface display 300 enhances the effectiveness of the autonomous AI system for game testing and analysis. It enables stakeholders to quickly identify issues, track progress, and make informed decisions based on comprehensive, AI-driven insights.

The autonomous AI system for game testing and analysis incorporates several key components and processes, as illustrated in FIGS. 1-5. These figures provide a comprehensive overview of the system's architecture, workflow, and user interface.

FIG. 2 depicts a flowchart of the process 100 for game testing and analysis. The process 100 begins with step 110, which represents the input of a game file for testing. This game file undergoes processing in step 120, which serves as the core testing engine. From step 120, the process branches into three specialized functions: step 130 for design analysis, step 140 for bug tracking, and step 150 for generating conversational feedback. The design analyzer in step 130 examines various aspects of the game design, including gameplay mechanics, difficulty progression, and user experience. The bug tracker in step 140 identifies and categorizes software issues encountered during testing. The chat generator in step 150 transforms technical data into human-readable feedback.

FIG. 3 illustrates the feedback system diagram 200, showcasing the interaction between key components of the autonomous AI system. The game module 210 provides input to the ai module 220, which processes the game information. The processed data then flows to the NLP feedback module 230, which generates natural language feedback that loops back to the game module 210. The feedback system diagram 200 demonstrates the continuous flow of information between these modules, enabling adaptive testing and refinement of analysis over time. This iterative process ensures that the system evolves and improves its testing and evaluation capabilities with each cycle.

FIG. 4 presents the user interface display 300 of the autonomous AI system. The user interface display 300 is designed to provide stakeholders with a comprehensive view of the testing process, analysis results, and system status information. The information header 302 at the top of the display contains essential details about the current testing session. The status window 304 and status indicator 310 provide real-time updates on system operations. The comparative graph 306 presents time-based results data in a visual format, allowing users to quickly assess trends and patterns. The gameplay window 312 showcases the current game being analyzed, providing a real-time view of the AI-driven gameplay simulation. Adjacent to the gameplay window 312, the analysis module 314 and feedback interface 316 present detailed insights and enable user interaction with the system's natural language processing capabilities. The results panel 318 summarizes key findings from the testing and analysis processes, while the metrics display 320 presents quantitative data related to the testing process. The compliance window 308 and compliance indicator 322 provide information on how well the game adheres to various testing standards and quality benchmarks. At the bottom of the user interface display 300, the status report 324 offers a comprehensive overview of the testing session, including summaries of detected issues, performance evaluations, and design recommendations.

The autonomous AI system for game testing and analysis includes a cross-game benchmarking module. This module operates as part of the process 100 illustrated in FIG. 2, integrating with the design analyzer in step 130 and the bug tracker in step 140. The cross-game benchmarking module compares performance metrics, design elements, and bug occurrences across multiple games, providing valuable insights into industry standards and best practices. The cross-game benchmarking module utilizes data collected from various games tested by the system, stored within the ai module 220 shown in FIG. 3. This module analyzes patterns and trends across different games, identifying common issues, successful design elements, and performance benchmarks. The results of this cross-game analysis are presented through the user interface display 300, specifically within the analysis module 314 and the results panel 318.

By incorporating cross-game benchmarking, the autonomous AI system for game testing and analysis provides developers with contextual insights, allowing them to understand how their game performs relative to industry standards and similar titles. This feature enhances the overall value of the system, offering a broader perspective on game quality and design effectiveness.

One aspect of the invention shown in FIG. 1 is a computing system 400 for automated game testing and analysis. The computing system 400 includes an installation module 410 for automated game installation and a gameplay simulation engine 420 using AI agents. The computing system 400 includes a telemetry and bug detection layer 430. The computing system 400 includes a design analysis module 440, a natural-language feedback interface 450 and a multi-user review layer 460. The computing system 400 installs a game into a virtual environment, launches and simulates gameplay using AI agents, collects gameplay telemetry and detects bugs, analyzes design metrics, and generates feedback in conversational language. The installation module 410 may operate within secure sandbox or emulation environments. The installation module 410 may provide real-time progress indicators 412 and status reporting 414 during game installation. The gameplay simulation engine 420 may use reinforcement learning algorithms to enable AI agents 490 to autonomously navigate and play test scenarios without predefined scripts. The gameplay simulation engine 420 may incorporate decision-tree methodologies for AI agent 490 decision-making. The telemetry and bug detection layer 430 collects comprehensive gameplay data during the AI-driven testing process. This data includes player actions, in-game events, performance metrics, and system-level information. The telemetry and bug detection layer 430 utilizes advanced telemetry techniques to capture a wide range of data points, enabling thorough analysis of game behavior and performance. In conjunction with data collection, the telemetry and bug detection layer employs computer vision techniques to analyze the visual output of the game. The computer vision-based approach allows for the detection of graphical glitches, rendering issues, and other visual anomalies that traditional data-based methods might miss. The system processes the game's visual output in real-time, comparing it against expected visual patterns and identifying deviations. The telemetry and bug detection layer 430 may use computer vision equipment 432 and techniques to analyze visual output of the game for graphical glitches and rendering issues. The telemetry and bug detection layer 430 may employ machine learning analytics 434 to identify patterns and anomalies in collected gameplay data. The design analysis module 440 may evaluate core gameplay mechanics, difficulty progression, reward structures, and overall user experience flow. The design analysis module 440 may identify gameplay design flaws, frustration points, and user-experience bottlenecks through continuous AI-driven analysis 442.

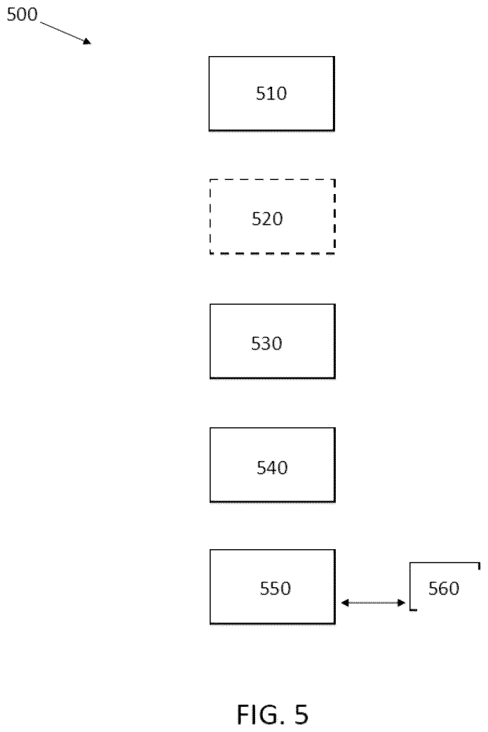

Another aspect of the invention as shown in FIG. 5 is a method 500 for automated game testing and analysis. The method includes a step 510 of automatically installing a game into a virtual environment and a step 530 of simulating gameplay using AI agents. The step 510 of automatically installing the game may include a step 520 creating a sandboxed environment within which to install and run the game. The step 530 of simulating gameplay using AI agents may use reinforcement learning algorithms to enable the AI agents to autonomously navigate and play test scenarios without predefined scripts. The method 500 includes a step 540 of collecting gameplay telemetry and detecting bugs. The step 540 of collecting gameplay telemetry and detecting bugs may use computer vision techniques to analyze visual output of the game for graphical glitches and rendering issues. The method 500 includes a step 550 of analyzing game design metrics and generating feedback 560 in conversational language. The method may include providing real-time progress indicators and status reporting during game installation. The method may include incorporating decision-tree methodologies for AI agent decision-making during gameplay simulation. The method may include employing machine learning analytics to identify patterns and anomalies in collected gameplay data for bug detection and categorization.

Another aspect of the invention is a non-transitory computer-readable medium storing instructions that, when executed by a processor, cause the processor to perform operations for automated game testing and analysis. The operations include installing a game into a virtual environment, simulating gameplay using AI agents, collecting gameplay telemetry and detecting bugs, analyzing game design metrics, and generating feedback in conversational language. Installing the game may create a sandboxed environment within which to install and run the game. Operations may include providing real-time progress indicators and status reporting during game installation. Simulating gameplay using AI agents may include employing reinforcement learning algorithms to enable the AI agents to autonomously navigate and play test scenarios without predefined scripts.

A number of implementations have been described. Nevertheless, it will be understood that various modifications may be made without departing from the spirit and scope of the disclosure. Accordingly, other implementations are within the scope of the following claims.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computing system for automated game testing and analysis, the computing system comprising:
an installation module configured to automate game installation;
a gameplay simulation engine using AI agents;
a telemetry and bug detection layer;
a design analysis module;
a natural-language feedback interface; and
a multi-user review layer,
wherein the computing system installs a game into a virtual environment, launches and simulates gameplay using AI agents, collects gameplay telemetry and detects bugs, analyzes design metrics, and generates feedback in conversational language.

2. The computing system of claim 1, wherein the installation module operates within secure sandbox or emulation environments.

3. The computing system of claim 1, wherein the installation module provides real-time progress indicators and status reporting during game installation.

4. The computing system of claim 1, wherein the gameplay simulation engine uses reinforcement learning algorithms to enable AI agents to autonomously navigate and play test scenarios without predefined scripts.

5. The computing system of claim 1, wherein the gameplay simulation engine incorporates decision-tree methodologies for AI agent decision-making.

6. The computing system of claim 1, wherein the telemetry and bug detection layer utilizes computer vision techniques to analyze visual output of the game for graphical glitches and rendering issues.

7. The computing system of claim 1, wherein the telemetry and bug detection layer employs machine learning analytics to identify patterns and anomalies in collected gameplay data.

8. The computing system of claim 1, wherein the design analysis module evaluates core gameplay mechanics, difficulty progression, reward structures, and overall user experience flow.

9. The computing system of claim 1, wherein the design analysis module is configured to identify gameplay design flaws, frustration points, and user-experience bottlenecks through continuous AI-driven analysis. x. The computing system of claim 1, wherein the computing system is integratable with external project management tools.

10. A method for automated game testing and analysis, comprising:
automatically installing a game into a virtual environment;
simulating gameplay using AI agents;
collecting gameplay telemetry and detecting bugs;
analyzing game design metrics; and
generating feedback in conversational language.

11. The method of claim 10, wherein automatically installing the game comprises creating a sandboxed environment within which to install and run the game.

12. The method of claim 10, further comprising providing real-time progress indicators and status reporting during game installation.

13. The method of claim 10, wherein simulating gameplay using AI agents comprises employing reinforcement learning algorithms to enable the AI agents to autonomously navigate and play test scenarios without predefined scripts.

14. The method of claim 10, further comprising incorporating decision-tree methodologies for AI agent decision-making during gameplay simulation.

15. The method of claim 10, wherein collecting gameplay telemetry and detecting bugs comprises utilizing computer vision techniques to analyze visual output of the game for graphical glitches and rendering issues.

16. The method of claim 10, further comprising employing machine learning analytics to identify patterns and anomalies in collected gameplay data for bug detection and categorization.

17. A non-transitory computer-readable medium storing instructions that, when executed by a processor, cause the processor to perform operations for automated game testing and analysis, the operations comprising:
installing a game into a virtual environment;
simulating gameplay using AI agents;
collecting gameplay telemetry and detecting bugs;
analyzing game design metrics; and
generating feedback in conversational language.

18. The non-transitory computer-readable medium of claim 17, wherein installing the game comprises creating a sandboxed environment within which to install and run the game.

19. The non-transitory computer-readable medium of claim 17, wherein the operations further comprise providing real-time progress indicators and status reporting during game installation.

20. The non-transitory computer-readable medium of claim 17, wherein simulating gameplay using AI agents comprises employing reinforcement learning algorithms to enable the AI agents to autonomously navigate and play test scenarios without predefined scripts.
